(19) United States
(12) Patent Application Publication
(10) Pub. No.: US 2025/0340451 A1
(43) Pub. Date: Nov. 6, 2025

(54) MATERIALS, METHODS AND TECHNIQUES FOR THE SELECTIVE EXTRACTION OF CERIUM FROM RARE EARTH SULFATES SOLUTIONS

(71) Applicant: Lynas Rare Earths Limited, Perth (AU)

(72) Inventors: Muhammad Khair Khadri, Temerloh (MY); Nurfarahiyah Abd Udzir, Kuantan (MY); Norazihan Zulkifli, Kuantan (MY); Luke Darbyshire, Roleystone (AU); Mohd Azlan Mat Ali, Kuantan (MY)

(21) Appl. No.: 19/061,374

(22) Filed: Feb. 24, 2025

Related U.S. Application Data
(60) Provisional application No. 63/642,171, filed on May 3, 2024.

(51) Int. Cl. C01F 17/282; C22B 3/22; C22B 3/44; C22B 59/00

(52) U.S. Cl. CPC C01F 17/282; C22B 3/22; C22B 3/44; C22B 59/00

(57) ABSTRACT

Mixed rare earth sulfate solutions depleted of cerium may be prepared by mixing a mixed rare earth sulfate solution with a pH adjusting agent comprising a magnesium oxide, and adding a sulfate adjusting agent comprising magnesium sulfate to the mixed rare earth sulfate solution, thereby generating a mixture; adding an oxidizing agent to the mixture thereby generating a slurry comprising insoluble cerium (IV) hydroxide, the oxidizing agent comprising hydrogen peroxide (H₂O₂); and filtering the slurry, thereby generating a cerium depleted mixed rare earth sulfate solution and cerium-rich mixed rare earth solids.

### CROSS-REFERENCE TO RELATED APPLICATION(S)

This application claims priority to U.S. Provisional Patent Application No. 63/642,171, filed on May 3, 2024, the entire contents of which are incorporated herein by reference.

### TECHNICAL FIELD

The present disclosure relates to mixed rare earth sulfate solutions. More specifically, materials, systems, and methods disclosed and contemplated herein relate to the production of mixed rare earth sulfate solutions from which cerium has been selectively extracted (“cerium depleted mixed rare earth sulfate solutions”).

### INTRODUCTION

Rare earths may be obtained by processing mined rare earth minerals. These mined rare earth minerals are processed in a sequential manner until they are of a form that may be used as an input to rare earth separation processes. Monazite, a rare earth mineral, is processed by mining and acid cracking using concentrated sulfuric acid, followed by leaching in water. The output of this sequential process is often a mixed rare earth sulfate solution. Before the mixed rare earth sulfate solution may be introduced into a solvent extraction process to separate the rare earth elements, the mixed rare earth sulfate solution may be depleted of cerium to produce a mixed rare earth sulfate solution with low cerium, which may be further processed to isolate various rare earths of interest.

### SUMMARY

In some aspects, the techniques described herein relate to method for preparing a mixed rare earth sulfate solution depleted of cerium, the method comprising: mixing a mixed rare earth sulfate solution with a pH adjusting agent comprising a magnesium oxide, and adding a sulfate adjusting agent comprising magnesium sulfate to the mixed rare earth sulfate solution, thereby generating a mixture; adding an oxidizing agent to the mixture thereby generating a slurry comprising insoluble cerium (IV) hydroxide, the oxidizing agent comprising hydrogen peroxide (H₂O₂); and filtering the slurry, thereby generating a cerium depleted mixed rare earth sulfate solution and cerium-rich mixed rare earth solids.

In some aspects, the techniques described herein relate to a system for generating cerium depleted mixed rare earth sulfate solutions, the system comprising: a vessel in communication with a mixed rare earth sulfate solution source, a magnesium oxide (MgO) solution source, a magnesium sulfate (MgSO₄) source, and a hydrogen peroxide (H₂O₂) source, the vessel comprising agitation apparatus; and a filter unit in fluid communication with the vessel.

There is no specific requirement that a material, technique, or method relating to cerium depleted mixed rare earth sulfate solutions include all the details characterized herein to obtain some benefit according to the present disclosure. Thus, the specific examples characterized herein are meant to be exemplary applications of the techniques described, and alternatives are possible.

### BRIEF DESCRIPTION OF THE DRAWINGS

FIG. 1 is a schematic depiction of an exemplary system for generating cerium depleted mixed rare earth sulfate solutions.

FIG. 2 is a schematic depiction of an exemplary washing system for exemplary systems for generating cerium depleted mixed rare earth sulfate solutions.

FIG. 3 is a graph showing cerium removal rates (% by weight (wt. %)) after example cerium removal operations.

FIG. 4 is a graph showing design of experiment (DOE) removal rates (wt. %) for cerium and other light rare earth elements (lanthanum (La), praseodymium (Pr), and neodymium (Nd)) after example cerium removal operations.

### DETAILED DESCRIPTION

Materials, methods, and techniques disclosed and contemplated herein relate to generating cerium depleted mixed rare earth sulfate solutions. Exemplary cerium depleted mixed rare earth sulfate solutions may be generated with cerium removal operations. These cerium removal operations may be performed as continuous processes. Exemplary cerium depleted mixed rare earth sulfate solutions may have greater than 20 wt. % removal of cerium from a mixed rare earth sulfate solution.

### I. DEFINITIONS

Unless otherwise defined, all technical and scientific terms used herein have the same meaning as commonly understood by one of ordinary skill in the art. In case of conflict, the present document, including definitions, will control. Methods and materials are described below, although methods and materials similar or equivalent to those described herein can be used in practice or testing of the present disclosure. All publications, patent applications, patents and other references mentioned herein are incorporated by reference in their entirety. The materials, methods, and examples disclosed herein are illustrative only and not intended to be limiting.

The terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “an” and “the” include plural references unless the context clearly dictates otherwise. The present disclosure also contemplates other embodiments “comprising,” “consisting of” and “consisting essentially of,” the embodiments or elements presented herein, whether explicitly set forth or not.

The modifiers “about” or “approximately” used in connection with a quantity are inclusive of the stated value and has the meaning dictated by the context (for example, it includes at least the degree of error associated with the measurement of the quantity). These modifiers should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9-1.1. Other meanings of “about” may be apparent from the context, such as rounding off, so, for example “about 1” may also mean from 0.5 to 1.4.

For the recitation of numeric ranges herein, each intervening number there between with the same degree of precision is contemplated. For example, for the range of 6-9, the numbers 7 and 8 are contemplated in addition to 6 and 9, and for the range 6.0-7.0, the numbers 6.0, 6.1, 6.2, 6.3, 6.4, 6.5, 6.6, 6.7, 6.8, 6.9, and 7.0 are contemplated. For another example, when a pressure range is described as being between ambient pressure and another pressure, a pressure that is ambient pressure is expressly contemplated.

Definitions of specific functional groups and chemical terms are described in more detail below. For purposes of this disclosure, the chemical elements are identified in accordance with the Periodic Table of the Elements, CAS version, Handbook of Chemistry and Physics, 104^{th} Ed., inside cover, and specific functional groups are defined as described therein.

### II. EXEMPLARY MATERIALS

Exemplary methods and techniques use and generate various materials. Example materials include mixed rare earth sulfate solutions, oxidizing agents, pH adjusting agents, sulfate adjusting agents, cerium-rich mixed rare earth solids, cerium depleted mixed rare earth sulfate solutions, and washing solutions.

### A. Exemplary Mixed Rare Earth Sulfate Solutions

Exemplary mixed rare earth sulfate solutions are solutions comprising one or more rare earth components dissolved in a sulfate solution. In some instances, mixed rare earth sulfate solutions are generated from monazite cracking and leaching unit operations.

Example mixed rare earth sulfate solutions may include various rare earth elements (REEs). Exemplary rare earth elements include lanthanum (La), cerium (Ce), neodymium (Nd), praseodymium (Pr), samarium (Sm), europium (Eu), gadolinium (Gd), terbium (Tb), dysprosium (Dy), holmium (Ho), erbium (Er), thulium (Tm), ytterbium (Yb), and/or lutetium (Lu).

Exemplary rare earth elements may be characterized as light rare earth elements (LREEs) or heavy rare earth elements (HREEs). As used herein, the term “light rare earth elements” or “LREEs” refers to lanthanum (La), cerium (Ce), praseodymium (Pr), and neodymium (Nd). As used herein, the term “heavy rare earth elements” of “HREEs” refers to samarium (Sm), europium (Eu), gadolinium (Gd), terbium (Tb), dysprosium (Dy), holmium (Ho), erbium (Er), thulium (Tm), ytterbium (Yb), and lutetium (Lu).

Exemplary rare earth elements may be present in the mixed rare earth sulfate solutions as rare earth oxides (REOs). Examples of rare earth oxides (REOs) include lanthanum oxide (La₂O₃), cerium oxide (CeO₂), neodymium oxide (Nd₂O₃), and praseodymium oxide (Pr₆O₁₁).

In some instances, cerium (Ce) comprises 30% by weight (wt. %) to 50 wt. %. of the total amount of rare earth elements (REEs) in the mixed rare earth sulfate solutions. In some instances, cerium (Ce) comprises 31 wt. % to 49 wt. %; 32 wt. % to 48 wt. %; 33 wt. % to 47 wt. %; 34 wt. % to 46 wt. %; 35 wt. % to 45 wt. %; 36 wt. % to 44 wt. %; 37 wt. % to 43 wt. %; 38 wt. % to 42 wt. %; or 39 wt. % to 41 wt. % of the total amount of rare earth elements (REEs) in the mixed rare earth sulfate solutions. In some instances, cerium (Ce) comprises no less than 30 wt. %; no less than 32 wt. %; no less than 35 wt. %; no less than 37 wt. %; no less than 40 wt. %; no less than 42 wt. %; no less than 45 wt. %; or no less than 47 wt. % of the total amount of rare earth elements (REEs) in the mixed rare earth sulfate solutions. In some instances, cerium (Ce) comprises no more than 50 wt. %; no more than 48 wt. %; no more than 45 wt. %; no more than 43 wt. %; no more than 40 wt. %; no more than 38 wt. %; no more than 35 wt. %; no more than 33 wt. % of the total amount of rare earth elements (REEs) in the mixed rare earth sulfate solutions.

In some instances, exemplary mixed rare earth sulfate solutions comprise one or more impurities. Example impurities include silica (SiO₂), iron (Fe), aluminum (Al), and calcium (Ca).

In some instances, mixed rare earth sulfate solutions may have a total rare earth oxide (TREO) concentration of concentration of 0.1 moles total rare earth oxide (TREO) per liter (“moles TREO/L”) to 0.2 moles TREO/L. “Total Rare Earth Oxide (TREO) concentration” refers to the total amount of rare earth elements (REEs) present in a sample, expressed as rare earth oxides (REOs). In various implementations, exemplary mixed rare earth sulfate solutions may have a total rare earth oxide (TREO) concentration of no less than 0.10 moles TREO/L; no less than 0.12 moles TREO/L; no less than 0.15 moles TREO/L; no less than 0.17 moles TREO/L; or no less than 0.20 moles TREO/L. In various implementations, exemplary mixed rare earth sulfate solutions may have a total rare earth oxide (TREO) concentration of no more than 0.20 moles TREO/L; no more than 0.17 moles TREO/L; no more than 0.15 moles TREO/L; or no more than 0.12 moles TREO/L.

In some instances, mixed rare earth sulfate solutions may have a pH of 0.5 to 2.0. In some instances, mixed rare earth sulfate solutions may have a pH of 0.6 to 1.9; 0.7 to 1.8; 0.8 to 1.7; 0.9 to 1.6; 1.0 to 1.5; 1.1 to 1.4; or 1.2 to 1.3. In some instances, mixed rare earth sulfate solutions may have a pH of no less than 0.5; no less than 0.6; no less than 0.7; no less than 0.8; no less than 0.9; no less than no less than 1.0; no less than 1.1; no less than 1.2; no less than 1.3; no less than 1.4; no less than 1.5; no less than 1.6; no less than 1.7; or no less than 1.8. In some instances, mixed rare earth sulfate solutions may have a pH of no more than 2.0; no more than 1.9; no more than 1.8; no more than 1.7; no more than 1.6; no more than 1.5; no more than 1.4; no more than 1.3; no more than 1.2; no more than 1.1; no more than 1.0; no more than 0.9; or no more than 0.8.

### B. Exemplary Oxidizing Agents

Exemplary oxidizing agents may comprise hydrogen peroxide (H₂O₂) solutions, ozone (O₃), sodium hypochlorite (NaOCl), and/or potassium permanganate (KMnO₄). In some instances, exemplary oxidizing agents may consist of, or may consist essentially of, hydrogen peroxide (H₂O₂) solution.

In some instances, a concentration of the hydrogen peroxide (H₂O₂) solution may be 5 wt. % to 30 wt. %. In various implementations, a concentration of the hydrogen peroxide (H₂O₂) solution may be 7 wt. % to 28 wt. %; 10 wt. % to 25 wt. %; 12 wt. % to 23 wt. %; or 15 wt. % to 20 wt. %. In various implementations, a concentration of the hydrogen peroxide (H₂O₂) solution may be no less than 5 wt. %; no less than 10 wt. %; no less than 15 wt. %; no less than 20 wt. %; no less than 25 wt. %; or no less than 30 wt. %. In various implementations, a concentration of the hydrogen peroxide (H₂O₂) solution may be no more than 30 wt. %; no more than 25 wt. %; no more than 20 wt. %; no more than 15 wt. % or no more than 10 wt. %. In various implementations, a concentration of the hydrogen peroxide (H₂O₂) solution may be 5-10 wt. %; 10-20 wt. %; or 20-30 wt. %.

### C. Exemplary pH Adjusting Agents

Exemplary pH adjusting agents may be basic or acidic. Exemplary basic pH adjusting agents comprise sodium hydroxide (NaOH), potassium hydroxide (KOH), magnesium oxide (MgO), and/or calcium hydroxide (Ca(OH)₂). Exemplary acidic pH adjusting agents may comprise hydrogen peroxide (H₂O₂).

### D. Exemplary Sulfate Adjusting Agents

Exemplary systems, methods and techniques may use sulfate adjusting agents. During cerium removal operations, exemplary sulfate adjusting agents may be added to control the reaction mixture's sulfate (SO₄) to cerium molar ratio and improve filterability of the products.

Exemplary sulfate adjusting agents may comprise one or more sulfate (SO₄⁻²) salts. Exemplary sulfate salts may comprise ammonium sulfate ((NH₄)₂SO₄), sodium sulfate (Na₂SO₄), potassium sulfate (K₂SO₄), magnesium sulfate (MgSO₄), and/or calcium sulfate (CaSO₄).

### E. Exemplary Cerium-Rich Mixed Rare Earth Solids

Exemplary systems, methods and techniques may generate cerium-rich mixed rare earth solids. The term “rich” is used solely to indicate relative cerium contents in different mixed rare earth solids precipitated after the oxidation processes.

Exemplary cerium-rich mixed rare earth solids may be generated as solid filter cakes having various cerium contents. The cerium content of the cerium-rich mixed rare earth solids may be defined relative to the cerium content of the initial mixed rare earth sulfate mixed earth solution.

In some instances, cerium-rich mixed rare earth solids may comprise a cerium content that is greater than 95 wt. % of the cerium content present in the initial mixed rare earth sulfate solution. Put another way, at least 95 wt. % of the cerium in the initial mixed rare earth sulfate solutions has been recovered in exemplary cerium-rich mixed rare earth solids.

In various instances, the cerium-rich mixed rare earth solids may comprise cerium at 95 wt. % to 99.9 wt. %. In various instances, the cerium-rich mixed rare earth solids may comprise cerium at 95 wt. % to 99 wt. %; 96 wt. % to 98 wt. %; or 97 wt. % to 98 wt. %. In various instances, the cerium-rich mixed rare earth solids may comprise cerium at no less than 95 wt. %; no less than 96 wt. %; no less than 97 wt. %; no less than 98 wt. %; or no less than 99 wt. %. In various instances, the cerium-rich mixed rare earth solids may comprise cerium at no more than 99.9 wt. %; no more than 99 wt. %; no more than 98 wt. %; no more than 97 wt. %; or no more than 96 wt. %.

In various instances, the cerium-rich mixed rare earth solids may comprise a non-cerium rare earth element content that is no more than 5 wt. % of the non-cerium rare earth element content present in the initial mixed rare earth sulfate solution. In some instances, the cerium-rich mixed rare earth solids may comprise a non-cerium rare earth element content that is no more than 4 wt. %; no more than 3 wt. %; no more than 2 wt. %; or no more than 1 wt. % of the non-cerium rare earth element content present in the initial mixed rare earth sulfate solution.

### F. Exemplary Cerium Depleted Mixed Rare Earth Sulfate Solutions

Exemplary systems, methods and techniques may generate various filtrates comprising cerium depleted mixed rare earth sulfate solutions. The term “depleted” is used solely to indicate relative cerium contents in different mixed rare earth sulfate solutions after oxidation processes. Exemplary “cerium depleted mixed rare earth sulfate solutions” are distinguished from “cerium-rich mixed rare earth sulfate solutions” in terms of cerium removal rate. Exemplary cerium depleted mixed rare earth sulfate solutions may be generated as solutions having various cerium concentrations. The cerium concentrations of the cerium depleted mixed rare earth sulfate solutions may be defined relative to the cerium concentrations of the initial mixed rare earth sulfate mixed earth solutions.

In various implementations, exemplary cerium depleted mixed rare earth sulfate solutions comprise 1 wt. % to 5 wt. % of the cerium present in the initial mixed rare earth sulfate solutions. Put another way, at least 95 wt. % of the cerium in the initial mixed rare earth sulfate solutions has been removed in exemplary cerium depleted mixed rare earth sulfate solutions.

In some instances, exemplary cerium depleted mixed rare earth sulfate solutions may have a cerium removal rate of at least 95 wt. %; at least 96 wt. %; at least 97 wt. %; at least 98 wt. %; or at least 99 wt. %, relative to the amount of cerium in the corresponding initial mixed rare earth sulfate solutions. In some instances, exemplary cerium depleted mixed rare earth sulfate solutions may have a cerium removal rate between 95 wt. % and 99.9 wt. %; between 95 wt. % and 99 wt. %; between 95.5 wt. % and 98.5 wt. %; between 96 wt. % and 98 wt. %; between 96.5 wt. % and 97.5 wt. %; or between 96 wt. % and 97 wt. %, relative to the amount of cerium in the corresponding initial mixed rare earth sulfate solutions.

### G. Exemplary Washing Solutions

Exemplary systems and methods disclosed herein may use various washing solutions. In some implementations, the washing solution is water. The water may be deionized water.

In other implementations, the washing solution is a dilute acid solution. The dilute acid solution may be a dilute sulfuric acid solution. Exemplary dilute acid solutions may have an acid concentration of 0.1 N to 0.5 N. In some instances, the dilute acid solution may have an acid concentration of 0.15 N to 0.45 N; 0.2 N to 0.4 N; or 0.25 N to 0.35 N. In some instances, the dilute acid solution may have an acid concentration of no more than 0.5 N; no more than 0.45 N; no more than 0.4 N; no more than 0.35 N; no more than 0.3 N; no more than 0.15 N; no more than 0.2 N; or no more than 0.15 N. In some instances, the dilute acid solution may have an acid concentration of no less than 0.1 N; no less than 0.15 N; no less than 0.2 N; no less than 0.25 N; no less than 0.3 N; no less than 0.35 N; no less than 0.4 N; or no less than 0.45 N.

### III. EXAMPLE METHODS

Example methods for preparing cerium depleted mixed rare earth sulfate solutions disclosed and contemplated herein may include one or more operations. Broadly, exemplary methods may include one or more pH adjustment operations, one or more sulfate to cerium ratio adjustment operations, one or more oxidation operations, one or more filtering operations, and one or more washing operations. In various implementations, some, most, or all operations in exemplary methods may be arranged and performed continuously.

An example method may begin by controlling the temperature of the mixed rare earth sulfate solution to be between 20° C. and 60° C. In some instances, controlling the temperature of the mixed rare earth sulfate solution may include heating the mixed rare earth sulfate solution. In various instances, the temperature of the mixed rare earth sulfate solution may be maintained between 30° C. and 60° C.; between 35° C. and 55° C.; or between 40° C. and 50° C. In various instances, the temperature of the mixed rare earth sulfate solution may be maintained at no less than 20° C.; no less than 25° C.; no less than 30° C.; no less than 35° C.; no less than 40° C.; no less than 45° C.; no less than 50° C.; or no less than 55° C. In various instances, the temperature of the mixed rare earth sulfate solution may be maintained at no more than 60° C.; no more than 55° C.; no more than 50° C.; no more than 45° C.; no more than 40° C.; no more than 35° C.; or no more than 30° C.

An example method may continue by adding a pH adjusting agent to the mixed rare earth sulfate solution. In some instances, the pH adjusting agent may be added to the mixed rare earth sulfate solution with mixing to form a homogeneous solution. Exemplary pH adjusting agents are described in greater detail above and may comprise a basic pH adjusting agent, such as magnesium oxide (MgO).

A total amount of pH adjusting agent added depends on the initial pH of the mixed rare earth sulfate solution. In some implementations, the initial pH of the mixed rare earth sulfate solution is about 2.0. In some implementations, the pH of the mixed rare earth sulfate solution is continuously monitored during the course of the pH adjustment with the pH adjusting agent. In some implementations, the pH adjusting agent is added to the mixed rare earth sulfate solution until a target pH range of 3.8 to 5.0 is achieved.

In some implementations, a pH of the mixed rare earth sulfate solution, after adding the pH adjusting agent, may be no less than 3.8; no less than 4.0; no less than 4.2; no less than 4.4; no less than 4.6; no less than 4.8, or no less than 5.0. In some implementations, a pH of the mixed rare earth sulfate solution, after adding the pH adjusting agent, may be no more than 5.0; no more than 4.8; no more than 4.6; no more than 4.4; no more than 4.2, no more than 4.0; or no more than 3.8. In some implementations, a pH of the mixed rare earth sulfate solution, after adding the pH adjusting agent, may be between 3.8 and 5.0; between 4.0 and 4.8; between 4.2 and 4.6; between 4.2 and 4.4; between 4.4 and 4.6; between 4.0 and 5.0; between 4.4 and 5.0; between 4.6 and 5.0; between 4.8 and 5.0; or between 3.8 to 4.0.

In some implementations, an example method may continue by adding a sulfate adjusting agent. Exemplary sulfate adjusting agents are described in greater detail above. As described above, exemplary sulfate adjusting agents may be added to control the sulfate to cerium ratio in the reaction mixture and improve filterability of the products. Exemplary sulfate adjusting agents may include sodium sulfate (Na₂SO₄), potassium sulfate (K₂SO₄), magnesium sulfate (MgSO₄), and/or calcium sulfate (CaSO₄).

In some instances, after adding the sulfate adjusting agent, the sulfate (SO₄) to cerium (Ce) molar ratio (SO₄/Ce) in the reaction mixture may be between 12.0 and 17.0. In some implementations, after adding the sulfate adjusting agent, the sulfate to cerium molar ratio (SO₄/Ce) may be no less than 12.0; no less than 13.0; no less than 14.0; no less than 15.0; no less than 16.0; or no less than 17.0. In some implementations, after adding the sulfate adjusting agent, the sulfate (SO₄) to cerium (Ce) molar ratio (SO₄/Ce) may be no more than 17.0; no more than 16; no more than 15; no more than 14; no more than 13; or no more than 12. In various instances, after adding the sulfate adjusting agent, the sulfate (SO₄) to cerium (Ce) molar ratio (SO₄/Ce) may be between 12.0 to 17.0; between 12.0 to 16.0; between 12.0 to 15.0; between 12.0 to about 14.0; between 12.0 to 13.0; between 13.0 to 16.0; between 13.0 to 15.0; between 13.0 to 14.0; between 14.0 to 16.0; between 14.0 to 16.0; or between 15.0 to 16.0.

In some instances, before adding an oxidizing agent, the method may comprise controlling the temperature of the reaction mixture. For example, the temperature of the reaction mixture may be controlled to be 50° C. to 70° C. In various implementations, a temperature of the reaction mixture may be controlled to be no less than 50° C.; no less than 55° C.; no less than 60° C.; no less than 65° C.; or no less than 70° C. In various implementations, the temperature of the slurry mixture may be controlled to be no more than about 70° C.; no more than 65° C.; no more than 60° C.; no more than 55° C.; or no more than 50° C. In various implementations, the temperature of the first mixture may be controlled to be between 50° C. and 70° C.; between 55° C. and 70° C.; between 60° C. and 70° C.; between 65° C. and 70° C.; between 55° C. and 60° C.; between 55° C. and 65° C.; or between 60° C. and 65° C.

An example method may continue by adding an oxidizing agent with mixing to the pH adjusted mixed rare earth sulfate solution. Adding an oxidizing agent to the pH adjusted mixed rare earth sulfate solution oxidizes soluble Ce(III) to insoluble Ce(IV) hydroxide (Ce(OH)₄), thereby forming a slurry or liquid-solid mixture. In some implementations, the oxidizing agent is hydrogen peroxide (H₂O₂). In other implementations, a different oxidizing agent may be used such as ozone (O₃), sodium hypochlorite (NaOCl), and/or potassium permanganate (KMnO₄).

In some instances, the oxidizing agent is added to the reaction mixture at a predetermined flow rate. In various instances, the oxidizing agent is added to the reaction mixture at a predetermined flow rate of 1.0 mL/min to 2.0 mL/min. In some implementations, the oxidizing agent is added to the reaction mixture at a flow rate of 1.1 mL/min to 1.9 mL/min; 1.2 mL/min to 1.8 mL/min; 1.3 mL/min to 1.7 mL/min; or 1.4 mL/min to 1.6 mL/min. In various instances, the oxidizing agent is added to the reaction mixture at a predetermined flow rate of no less than 1.0 mL/min; no less than 1.2 mL/min; no less than 1.5 mL/min; no less than 1.7 mL/min; or no less than 1.9 mL/min. In various instances, the oxidizing agent is added to the reaction mixture at a predetermined flow rate of no more than 2.0 mL/min; no more than 1.8 mL/min; no more than 1.5 mL/min; no more than 1.3 mL/min; or no more than 1.1 mL/min. In some implementations, the predetermined flow rate is maintained for a period of 2 hours for a volume of mixed rare earth sulfate of 3 liters.

The example method may include controlling a slurry temperature during oxidation. In some instances, controlling a slurry temperature may include heating the slurry. In various instances, a temperature of the slurry may be maintained at between 50° C. and 70° C. In various implementations, a temperature of the slurry may be maintained at no less than 50° C.; no less than 55° C.; no less than 60° C.; no less than 65° C.; or no less than 70° C. In various implementations, a temperature of the slurry may be maintained at 70° C.; no more than 65° C.; no more than 60° C.; no more than 55° C.; or no more than 50° C. In various implementations, a temperature of the slurry may be maintained at between 50° C. and 70° C.; between 55° C. and 70° C.; between 60° C. and 70° C.; between 65° C. and 70° C.; between 55° C. and 60° C.; between 55° C. and 65° C.; or between 60° C. and 65° C.

The example method may include controlling a pH of the slurry during oxidation. In some instances, controlling a pH of the slurry may include adding an acidic pH adjusting agent until a pH of 3.8 to 5.0 is achieved. In some instances, a pH of the slurry may be maintained between 3.8 and 5.0; between 4.0 and 4.8; between 4.2 and 4.6; between 4.2 and 4.4; between 4.4 and 4.6; between 4.0 and 5.0; between 4.4 and 5.0; between 4.6 and 5.0; between 4.8 and 5.0; or between 3.8 to 4.0. In some instances, a pH of the slurry may be maintained at no less than 3.8; no less than 4.0; no less than 4.2; no less than 4.4; no less than 4.6; or no less than 4.8. In some instances, a pH of the slurry may be maintained at no more than 5.0; no more than 4.8; no more than 4.6; no more than 4.4; no more than 4.2; or no more than 4.0.

In some instances, the example method includes mixing the slurry to promote the efficiency of oxidation of mixed rare earth sulfate solution to cerium depleted mixed rare earth sulfate solution. For example, mixing of the slurry may comprise axial mixing to ensure the slurry is homogeneous during the conversion process.

The example method may comprise agitating the slurry at a predetermined agitation speed. In various implementations, the agitation speed may be between 300 rotations per minute (rpm) and 950 rpm. In various implementations, the agitation speed may be 300 rpm to 900 rpm; 350 rpm to 850 rpm; 400 rpm to 800 rpm; 450 rpm to 750 rpm; 500 rpm to 700 rpm; or 550 rpm to 650 rpm. In various implementations, the agitation speed may be no less than 300 rpm; no less than 400 rpm; no less than 500 rpm; no less than 600 rpm; no less than 700 rpm; no less than 800 rpm; or no less than 900 rpm. In various implementations, the agitation speed may be no more than no more than 700 rpm, no more than 600 rpm, or no more than about 500 rpm.

The example method may comprise agitating the mixture for a predetermined period of time. In some instances, the mixture may be agitated for a time period between 1 hour and 10 hours; between 2 hours and 8 hours; between 2 hours and 6 hours; or between 2 hours and 4 hours. In various implementations, the mixture may be agitated for a time period of no less than 1 hour; no less than 2 hours; no less than 3 hours; no less than 4 hours; no less than 5 hours; no less than 6 hours; no less than 7 hours; no less than 8 hours; no less than 9 hours; or no less than 10 hours. In various implementations, the mixture may be agitated for a time period of no more than 10 hours; no more than 9 hours; no more than 8 hours; no more than 7 hours; no more than 6 hours; no more than 5 hours; no more than 4 hours; no more than 3 hours; no more than 2 hours; or no more than 1 hour.

After oxidation and agitating operations, the example method may comprise filtering the oxidized depleted cerium mixed rare earth sulfate solution. Filtering may include removing cerium-rich mixed rare earth solids from solution, wherein the cerium-rich mixed rare earth solids comprise excess cerium oxide and cerium (IV) hydroxide. The solids portion may be referred to as “filter cake.”

In some instances, the cerium-rich solids are transferred to another vessel or washing system and washed using a washing solution. Exemplary washing solutions are described in greater detail above. In some implementations, the washing solution is deionized water. In other implementations the washing solution is a dilute sulfuric acid solution. In some instances, the concentration of the dilute sulfuric acid solution ranges from 0.1 N to 0.5 N.

The washing step may be repeated one to three times. In some implementations, the filtrates comprising cerium depleted mixed rare earth sulfate solutions generated from the washing step(s) may be combined with the concentrated cerium depleted mixed rare earth sulfate solution.

In various instances, filtration operations may generate a solids portion comprising cerium-rich solids. Various aspects of exemplary cerium Exemplary cerium-rich solids may comprise between about 1 wt. % to about 15 wt. % of total rare earth oxides (TREO) of light rare earths. Exemplary light rare earths may comprise neodymium (Nd) and praseodymium (Pr).

In various instances, filtration operations may generate a liquid filtrate comprising a cerium depleted mixed rare earth sulfate solution.

### IV. EXAMPLE SYSTEMS

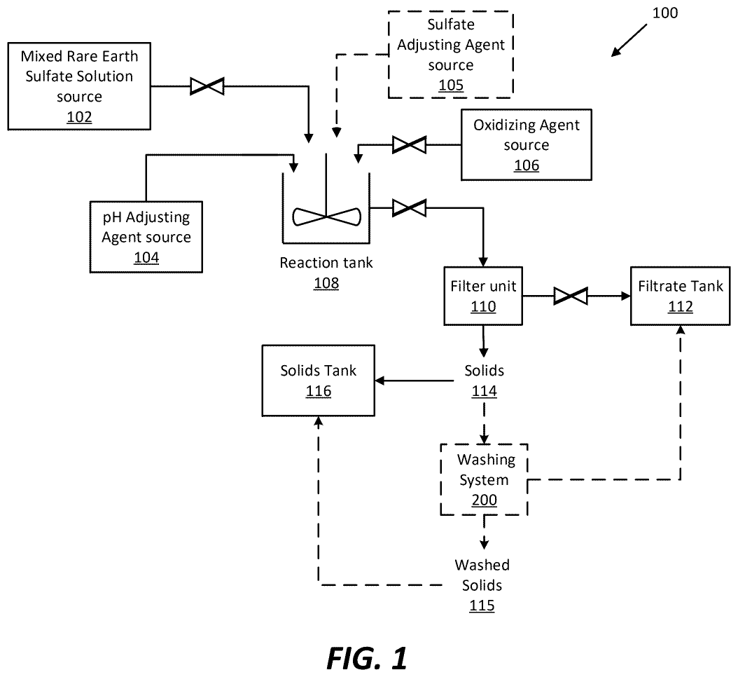

FIG. 1 is a schematic diagram of an exemplary system 100 for generating cerium depleted mixed rare earth sulfate solutions. System 100 includes mixed rare earth sulfate solution source 102, pH adjusting agent source 104, oxidizing agent source 106, reaction tank 108, filter unit 110, filtrate tank 112, and solids tank 116. Optional components are shown in dotted outline. Other embodiments may include more or fewer components.

As shown, a mixed rare earth sulfate solution source 102 is in fluid communication with a reaction tank 108. The mixed rare earth sulfate solution source 102 is configured to selectively provide rare earth sulfate to the reaction tank 108.

A pH adjusting agent source 104 may be in fluid communication with reaction tank 108. The pH adjusting agent source 104 may be configured to selectively provide a pH adjusting agent to reaction tank 108. Exemplary pH adjusting agents may comprise magnesium oxide (MgO). Other exemplary pH adjusting agents are described in greater detail above.

An oxidizing agent source 106 may be in fluid communication with reaction tank 108. Oxidizing agent source 106 may be configured to selectively provide an oxidizing agent to reaction tank 108. Exemplary oxidizing agents may comprise hydrogen peroxide (H₂O₂). Other exemplary oxidizing agents are described in greater detail above.

A sulfate adjusting agent source 105 may be in fluid communication with reaction tank 108. The sulfate material source may be configured to selectively provide sulfate material to reaction tank 108. Exemplary sulfate material may include magnesium sulfate (MgSO₄), although additional examples of sulfate material are described in greater detail above.

Reaction tank 108 may comprise agitation apparatus configured to agitate reactor tank contents.

Reaction tank 108 may comprise temperature control apparatus, not shown, configured to maintain or control the temperature of reaction tank 108 contents at various temperatures as described in greater detail above with reference to methods of operation, such as between 50° C. and 70° C.

Reaction tank 108 may comprise pH control apparatus configured to maintain or control the pH of reaction tank 108 contents. In some instances, pH control agent may selectively provide basic pH adjusting agent (e.g., MgO) and/or acidic pH adjusting agent (e.g., H₂O₂) to reaction tank 108 to achieve target pH ranges.

Filter unit 110 is in fluid communication with, and receives material from, reaction tank 108. Filter unit 110 separates solids 114 from the filtrate comprising cerium-depleted mixed rare earth sulfate solution. In some instances, solids 114 comprise cerium oxide and cerium (IV) hydroxide. In some instances, filter unit 110 may comprise a vacuum filter. Filtrate comprising cerium-depleted mixed rare earth sulfate solution may be provided to filtrate tank 112. Cerium-rich solids 114 may be stored in solids tank 116.

As shown in FIG. 1, optionally, in some instances, cerium-rich solids 114 may be provided to a washing system 200. Washing system 200 may include one or more washing tanks.

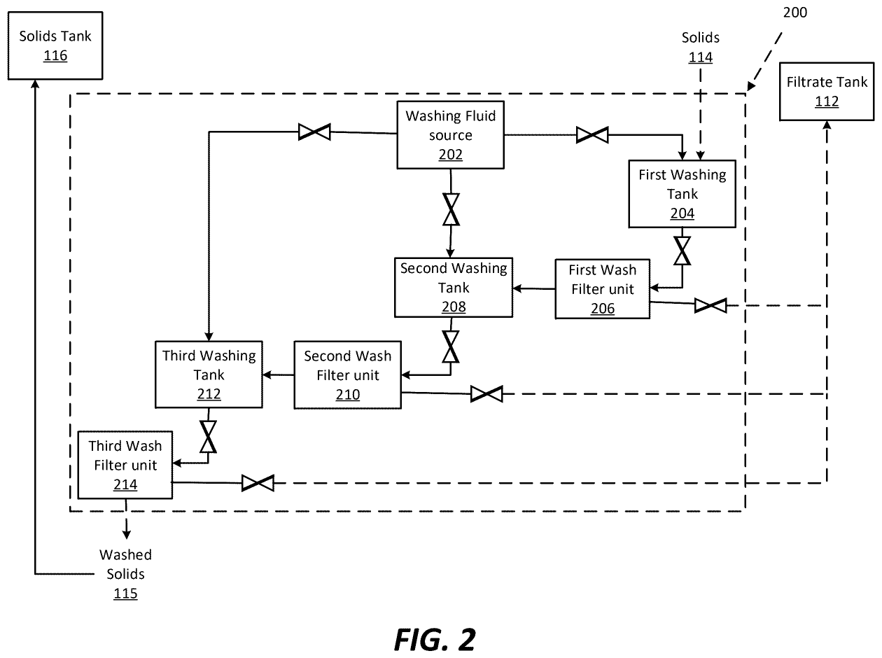

FIG. 2 is a schematic depiction of an exemplary washing system 200. As shown, exemplary washing system 200 comprises three washing tanks 204, 208, and 212. Other implementations may include more or fewer washing tanks. As shown in exemplary system 200, the washing tanks are arranged in series, although other implementations may comprise washing tanks arranged in parallel or both in series and in parallel.

Washing tanks 204, 208, and 212 are each in fluid communication with washing solution source 202. Moreover, washing tanks 204, 208 and 212 are each configured to receive washing solution from washing solution source 202. Exemplary washing solution are described above.

As shown, washing tanks 204, 208, and 212 provide an output to corresponding filter units 206, 210, and 214, respectively, where the washed solids are filtered. In some instances, washing tanks 204, 208, and/or 212 may provide filtrate to filtrate tank 112. As shown, resulting cerium hydroxy sulfate (cake) is provided from filter units 206, 210, and/or to solids tank 116. Various apparatus may be used to convey solids from the filter units to the subsequent operation or tank. In some instances, solids conveyors may be used.

### V. EXPERIMENTAL EXAMPLES

### A. Experimental Example 1

Several tests were conducted for cerium depletion operations in a design of experiments (DOE). The results are discussed below.

### 1. Raw Materials and Chemicals

Table 1 below provides details of the composition of mixed rare earth sulfate solutions used in the design of experiments.

TABLE 1
Details about the composition of mixed rare earth sulfate
solution ((RE)₂(SO₄)₃) (“RES”) used in the DOE.

| | Unit of | | | Unit of | |
|---|---|---|---|---|---|
| Analyte | Measure | Value | Analyte | Measure | Value |
| REO | Moles/L | 0.16 | Al | ppm | 478 |
| La₂O₃/REO | wt. % | 25.19 | As | ppm | 14 |
| CeO₂/REO | wt. % | 45.16 | Ba | ppm | 0.74 |
| Pr₆O₁₁/REO | wt. % | 5.26 | Ca | ppm | 720 |
| Nd₂O₃/REO | wt. % | 17.83 | Cu | ppm | — |
| Sm₂O₃/REO | wt. % | 3.35 | Fe | ppm | 79 |
| Eu₂O₃/REO | wt. % | 0.70 | Hg | ppm | — |
| Gd₂O₃/REO | wt. % | 1.34 | Mg | ppm | 8010 |
| Tb₄O₇/REO | wt. % | 0.20 | Mn | ppm | 607 |
| Dy₂O₃/REO | wt. % | 0.19 | Na | ppm | — |
| Y₂O₃/REO | wt. % | 0.69 | Ni | ppm | 1.46 |
| Ho₂O₃/REO | wt. % | 0.03 | Pb | ppm | 29 |
| Er₂O₃/REO | wt. % | 0.03 | Se | ppm | 3 |
| Tm₂O₃/REO | wt. % | <0.002 | Zn | ppm | 109 |
| Yb₂O₃/REO | wt. % | 0.03 | PO₄ | ppm | 49 |
| Lu₂O₃/REO | wt. % | <0.005 | SiO₂ | ppm | 356 |
| | | | SO₄ | wt. % | 5.84 |
| | | | pH | — | 3.66 |

Table 2 below provides details of the mixed light rare earth sulfate solutions used in the DOE.

TABLE 2
Details about the composition of mixed light rare
earth sulfate solution (LCPNS) used in the DOE.

| | Unit of | | | Unit of | |
|---|---|---|---|---|---|
| Analyte | Measure | Value | Analyte | Measure | Value |
| REO | Moles/L | 0.12 | Al | ppm | 455 |
| La₂O₃/REO | wt. % | 27.00 | As | ppm | — |
| CeO₂/REO | wt. % | 48.51 | Ba | ppm | — |
| Pr₆O₁₁/REO | wt. % | 5.61 | Ca | ppm | 792 |
| Nd₂O₃/REO | wt. % | 18.69 | Cu | ppm | 0.47 |
| Sm₂O₃/REO | wt. % | 0.11 | Fe | ppm | 35 |
| Eu₂O₃/REO | wt. % | 0.01 | Hg | ppm | 0.2 |
| Gd₂O₃/REO | wt. % | <0.001 | Mg | ppm | 10397 |
| Tb₄O₇/REO | wt. % | 0.04 | Mn | ppm | 701 |
| Dy₂O₃/REO | wt. % | 0.01 | Na | ppm | 22 |
| Y₂O₃/REO | wt. % | <0.002 | Ni | ppm | 2 |
| Ho₂O₃/REO | wt. % | 0.005 | Pb | ppm | 31 |
| Er₂O₃/REO | wt. % | 0.008 | Se | ppm | 5 |
| Tm₂O₃/REO | wt. % | <0.002 | Zn | ppm | 1 |
| Yb₂O₃/REO | wt. % | 0.01 | PO₄ | ppm | 84 |
| Lu₂O₃/REO | wt. % | <0.005 | SiO₂ | ppm | 591 |
| | | | SO₄ | wt. % | 7.79 |
| | | | pH | — | 2.11 |

### 2. Process Conditions

A mixed rare earth sulfate solution (Table 1) or mixed light rare earth sulfate solution (Table 2) was filtered, and then added into a vessel and agitated. An overhead agitator was used for mixing. The vessel contents were initially maintained at ambient temperature: 25° C.+/−2° C. without heating or cooling. The pH was continuously monitored using a pH probe and meter. The pH was manually adjusted in the pH range (pH 3.8 to 4.0) by adding a pH adjusting agent. The sulfate to cerium molar ratio was fixed by manually adding a sulfate containing solid (magnesium sulfate).

After pH adjustment and addition of sulfate adjusting agent, the process continued with the oxidation step. The temperature of the reaction mixture was increased to between 50° C. to 60° C. using a laboratory hot plate with temperature controller. The oxidizing agent (H₂O₂) was fed into the reaction mixture using a dosing pump to control the flowrate at 1.5 mL/min for a total volume of rare earth sulfate at 3 liters. The reaction mixture was aerated to assist with oxidation and mixing. Upon adding the oxidizing agent (H₂O₂), the pH of the reaction mixture dropped, and the color changed from clear light brown to dark brown. As the oxidation reaction progressed, the pH was maintained in a constant range (3.8 to 4.0) by manually adding the pH adjusting agent (MgO) to the reaction mixture. The oxidation reaction was allowed to occur over a period of two hours. Upon reaching 2 hours, the dosing of the oxidizing agent was stopped, which leads to a spike in pH resulting from any excess pH adjusting agent (MgO) in the reaction mixture. The pH was reduced by doping in additional oxidizing agent (H₂O₂) for a period of 2 to 4 hours maintaining the pH in range of 3.8 to 4.0 while maintaining the operating temperature (50° C. to 60° C.).

Once reaction time (4 to 6 hours) had been completed, the reaction mixture was filtered using an ESSA™ filter or pressure filter to obtain an unwashed filter cake and filtrate.

The unwashed filter cake was collected and weighed; the amount of wash solution required was calculated as 1 g REO of filter cake to 10 mL of deionized water. During the first wash, the unwashed filter cake was mixed with a predetermined amount of wash solution, stirred using agitator at 500 rpm for 15 minutes, filtered, and the solids were collected. The washing process was repeated an additional 2 times using the same technique to yield washed filter cake.

Table 3 below shows various process parameters for experimental conversion operations.

TABLE 3
Process parameters for experimental conversion operations following DOE.

| | Test 1 | Test 2 | Test 3 | Test 4 | Test 5 | Test 6 | Test 7 | Test 8 |
|---|---|---|---|---|---|---|---|---|
| Feed type | LCPNS | LCPNS | LCPNS | LCPNS | RES | RES | RES | RES |
| Feed concentration (g/L) | 22 | 22 | 22 | 22 | 25 | 25 | 25 | 25 |
| SO₄/Ce Ratio | 16.54 | 16.54 | 16.54 | 16.54 | 12.15 | 12.15 | 12.15 | 12.15 |
| H₂O₂ concentration (%) | 30 | 30 | 30 | 30 | 30 | 30 | 30 | 30 |
| Feed volume (L) | 3 | 3 | 3 | 3 | 3 | 3 | 3 | 3 |

Test condition

| | | | | | | | | |
|---|---|---|---|---|---|---|---|---|
| H₂O₂ flow (mL/min) - 2 hr | 1.5 | 1.5 | 1.5 | 1.5 | 1.5 | 1.5 | 1.5 | 1.5 |
| Reaction time (hrs) | 4 | 6 | 4 | 6 | 4 | 6 | 4 | 6 |
| Reaction temp (° C.) | 50 | 50 | 60 | 60 | 50 | 50 | 60 | 60 |
| Agitation speed (rpm) | 700 | 700 | 700 | 700 | 700 | 700 | 700 | 700 |
| Aeration | Yes | Yes | Yes | Yes | Yes | Yes | Yes | Yes |
| Reaction pH | 3.80-4.00 | 3.80-4.00 | 3.80-4.00 | 3.80-4.00 | 3.80-4.00 | 3.80-4.00 | 3.80-4.00 | 3.80-4.00 |

Washing conditions

| | | | | | | | | |
|---|---|---|---|---|---|---|---|---|
| Washing times | 3 | 3 | 3 | 3 | 3 | 3 | 3 | 3 |
| Washing temperature | Ambient | Ambient | Ambient | Ambient | Ambient | Ambient | Ambient | Ambient |
| Washing speed (rpm) | 500 | 500 | 500 | 500 | 500 | 500 | 500 | 500 |
| Filtration time | 15 | 15 | 15 | 15 | 15 | 15 | 15 | 15 |
| (per cycle) (min) | | | | | | | | |
| Mass of cake produced | 64.3 | 45.6 | 63.6 | 73.3 | 87.6 | 87.6 | 52.8 | 77.4 |
| (g) after sampling | | | | | | | | |
| Volume of dilute acid | 321.5 | 228 | 318 | 366.5 | 438 | 438 | 264 | 387 |
| required (per wash) (mL) | | | | | | | | |
| Total volume of dilute | 964.5 | 684 | 954 | 1099.5 | 1314 | 1314 | 792 | 1161 |
| acid required (mL) | | | | | | | | |

### 3. Cerium Depletion Operation Results

The initial level of cerium in the mixed rare earth sulfate solution ((RE)₂(SO₄)₃) was 45.1 wt. % while the initial level of cerium in the mixed light rare earth sulfate solution (LCPNSO₄) was 48.5 wt. % (FIG. 1). For both solutions, the initial level of cerium was measured as a percentage of total rare earth content (TREO). After 2-hour cerium depletion operation for the (RE)₂(SO₄)₃ solution, the cerium removal rate was 34.6 wt. % to 86.7 wt. %, while sum of light rare earth (neodymium (Nd) and praseodymium (Pr)) losses were from 8.7 wt. % to 13.7 wt. %. After 2-hour cerium depletion operation for the LCPNSO₄ solution, the cerium removal rate was 69.1 wt. % to 99.0 wt. %, while sum of light rare earth. (Nd and Pr) losses were from 8.4 wt. % to 14.4 wt. % (Table 2 and FIG. 1). The removal rate of Ce is mainly correlated with the operating pH, i.e., the higher operating pH would lead to a higher amount of Ce removed. However, this condition also results in non-cerium rare earths forming hydroxides which may be removed along with cerium.

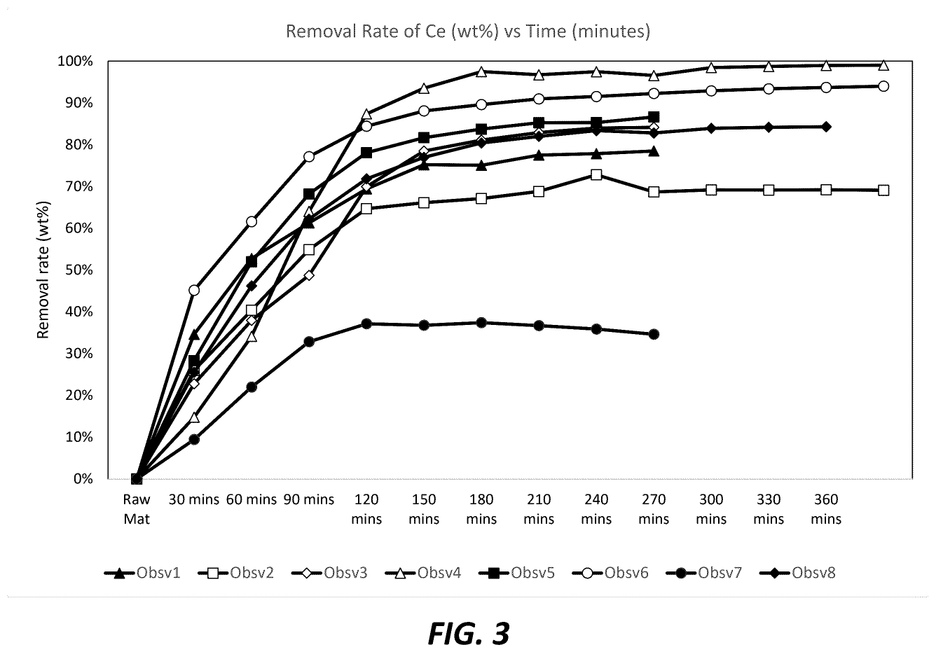

FIG. 3 shows removal rates for cerium after depleted mixed rare earth sulfate solution operations. Raw Mat is an example mixed rare earth sulfate solution prior to Ce removal operations.

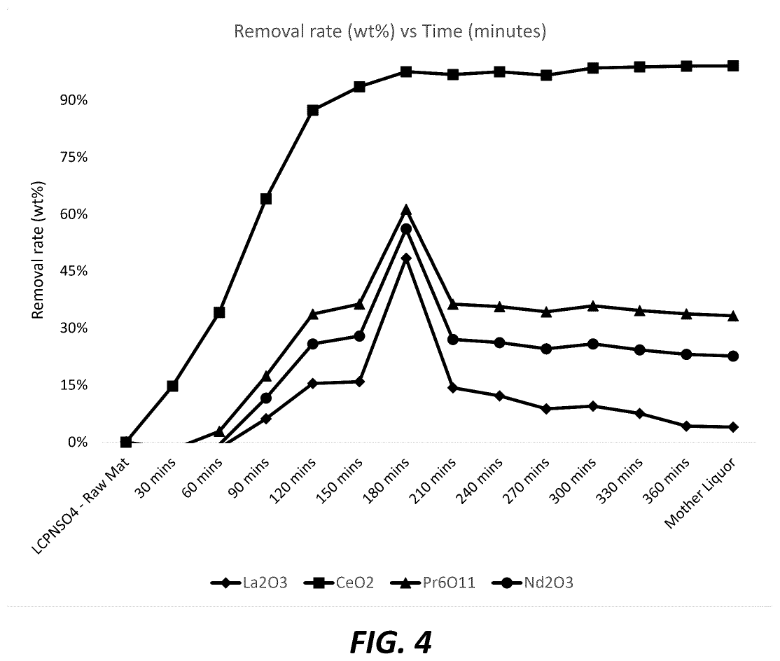

FIG. 4 shows DOE removal rates for cerium and other light rare earth elements (LREEs) after exemplary cerium depletion operations (Example—Test 4). Raw Mat is an example mixed rare earth sulfate solution prior to Ce removal operations. Mother liquor is the cerium depleted mixed rare earth sulfate solution after end of all Ce removal operations.

Table 4 below shows the DOE test results for concentrations of rare earth elements (REEs) in solid filter cakes as determined for washed solids.

TABLE 4
DOE test results - Concentrations of REEs in Filter-Cakes determined for washed solids.

| | Test 1 | Test 2 | Test 3 | Test 4 | Test 5 | Test 6 | Test 7 | Test 8 |
|---|---|---|---|---|---|---|---|---|
| La₂O₃/REO (wt. %) | 8.30 | 7.55 | 9.71 | 11.39 | 9.85 | 10.82 | 7.77 | 9.12 |
| CeO₂/REO (wt. %) | 82.30 | 83.79 | 78.90 | 73.96 | 76.15 | 72.88 | 82.06 | 77.85 |
| Pr₆O₁₁/REO (wt. %) | 2.58 | 2.35 | 3.04 | 3.72 | 3.18 | 3.58 | 2.44 | 2.95 |
| Nd₂O₃/REO (wt. %) | 6.78 | 6.09 | 8.32 | 10.72 | 8.65 | 10.12 | 6.27 | 8.03 |
| Sm₂O₃/REO (wt. %) | 0.12 | 0.14 | 0.14 | 0.13 | 1.47 | 1.74 | 0.99 | 1.38 |
| Eu₂O₃/REO (wt. %) | 0.01 | 0.00 | <0.001 | 0.00 | 0.24 | 0.29 | 0.16 | 0.22 |
| Gd₂O₃/REO (wt. %) | <0.001 | <0.001 | <0.001 | <0.001 | 0.26 | 0.33 | 0.18 | 0.26 |
| Tb₄O₇/REO (wt. %) | <0.002 | 0.08 | <0.002 | 0.07 | 0.10 | 0.12 | 0.08 | 0.11 |
| Dy₂O₃/REO (wt. %) | <0.002 | <0.002 | <0.002 | <0.002 | 0.00 | 0.03 | <0.002 | <0.002 |
| Y₂O₃/REO (wt. %) | <0.002 | <0.002 | <0.002 | <0.002 | 0.06 | 0.08 | 0.04 | 0.06 |
| Ho₂O₃/REO (wt. %) | <0.001 | <0.001 | <0.001 | <0.001 | 0.00 | 0.00 | <0.001 | <0.001 |
| Er₂O₃/REO (wt. %) | 0.02 | 0.01 | 0.02 | 0.01 | 0.02 | 0.02 | 0.02 | 0.02 |
| Tm₂O₃/REO (wt. %) | <0.002 | <0.002 | <0.002 | <0.002 | <0.002 | <0.002 | <0.002 | <0.002 |
| Yb₂O₃/REO (wt. %) | <0.005 | 0.01 | <0.005 | 0.01 | 0.01 | 0.01 | 0.01 | 0.01 |
| Lu₂O₃/REO (wt. %) | <0.005 | <0.005 | <0.005 | <0.005 | <0.005 | <0.005 | <0.005 | <0.005 |
| Total REO (g/kg) | 432 | 506 | 620 | 493 | 420 | 497 | 403 | 417 |
| Ce removal rate (wt. %) | 78.5 | 69.1 | 84.1 | 99.0 | 86.6 | 94.0 | 34.6 | 84.3 |
| NdPr/REO losses - Result | 9.4 | 8.4 | 11.4 | 14.4 | 11.8 | 13.7 | 8.7 | 11.0 |
| from cake (wt. %) | | | | | | | | |

### B. Experimental Example 2

Several tests were conducted for cerium depletion operations. The results are discussed below.

### 1. Raw Materials and Chemicals

Table 1 above provides details of the composition of mixed rare earth sulfate solutions used in this example.

### 2. Process Conditions

A mixed rare earth sulfate solution (Table 1) was filtered, added into a vessel, and agitated. An overhead agitator was used for mixing. The vessel contents were initially maintained at ambient temperature: 25° C.+/−2° C. without heating or cooling. The pH was continuously monitored using a pH probe and meter. The pH was manually adjusted in the pH range (pH 3.8-4.0) by adding the pH adjusting agent (magnesium oxide). The sulfate to cerium molar ratio was then fixed by manually adding the sulfate adjusting agent (magnesium sulfate).

After pH adjustment and addition of the sulfate adjusting agent, the process continued with oxidation. The temperature of the reaction mixture was increased to between 35° C. to 60° C. using a laboratory hot plate with temperature controller. The oxidizing agent (H₂O₂) was fed into the reaction mixture using a dosing pump to control the flowrate at 1.5 mL/min for a total volume of rare earth sulfate of 3 liters. The reaction mixture was aerated only in Tests 9 to 11. Upon adding the hydrogen peroxide (H₂O₂), the pH of the reaction mixture dropped, and the color changed from clear light brown to dark brown. As the oxidation reaction progressed, the pH was maintained in a constant range (3.8 to 4.0) by manually adding the pH adjusting agent (MgO) to the reaction mixture. The oxidation reaction was allowed to occur over a period of two hours. Upon reaching 2 hours, the dosing of the oxidizing agent was stopped, which led to a spike in pH resulting from any excess pH adjusting agent (MgO) in the reaction mixture. The pH was reduced by doping in additional oxidizing agent (H₂₂) for a period of 4 hours maintaining a pH in the range of 3.8 to 4.0 while maintaining the operating temperature (35° C. to 60° C.).

Once the reaction time (4 hrs.) had been completed, the reaction mixture was filtered using an ESSA™ or pressure filter to obtain an unwashed filter cake and filtrate.

The unwashed filter cake was collected and weighed; the amount of wash solution required was calculated as 1 g REQ of filter cake to 10 mL of deionized water or 0.21 M sulfuric acid solution. During the first wash, the unwashed filter cake was mixed with the necessary quantity of wash solution, stirred using agitator at 500 rpm for 15 minutes; filtered, and cerium-rich mixed rare earth solids were collected. The washing process was repeated an additional 2 times using the same technique to yield washed filter cake.

Table 5 below shows various process parameters for experimental conversion operations for Example 2.

TABLE 5
Process parameters for experimental conversion operations.

| | Test 9 | Test 10 | Test 11 | Test 12 | Test 13 |
|---|---|---|---|---|---|
| Feed type | RES | RES | RES | RES | RES |
| Feed concentration (g/L) | 26.65 | 26.65 | 26.65 | 26.65 | 26.65 |
| SO₄/Ce Ratio | 16-17 | 16-17 | 16-17 | 16-17 | 16-17 |
| H₂O₂ concentration | 30 | 30 | 30 | 30 | 30 |
| (wt. %) | | | | | |
| Feed volume (L) | 3 | 3 | 3 | 3 | 3 |
| H₂O₂ flow (mL/min) - | 1.5 | 1.5 | 1.5 | 1.5 | 1.5 |
| 2 hr | | | | | |
| Reaction time (hrs) | 4 | 4 | 4 | 4 | 4 |
| Reaction temp (° C.) | 60 | 60 | 35-40 | 35-40 | 50 |
| Agitation speed (rpm) | 700 | 700 | 700 | 700 | 700 |
| Aeration | Yes | Yes | Yes | No | No |
| Reaction pH | 3.8-4.0 | 3.8-4.0 | 3.8-4.0 | 3.8-4.0 | 3.8-4.0 |
| Concentration of dilute | 0.21 | 0.5 | 0.21 | 0.21 | 0.21 |
| acid (M) | | | | | |
| Washing times | 3 | 3 | 3 | 3 | 3 |
| Washing temperature | Ambi- | Ambi- | Ambi- | Ambi- | Ambi- |
| | ent | ent | ent | ent | ent |
| Washing speed (rpm) | 500 | 500 | 500 | 500 | 500 |
| Filtration time (per cycle) | 15 | 15 | 15 | 15 | 15 |
| (min) | | | | | |
| Mass of cake produced | 51 | 35 | 73.6 | 69 | 57 |
| (g) after sampling | | | | | |
| Volume of dilute acid | 255 | 175 | 368 | 345 | 285 |
| required (per wash) (mL) | | | | | |
| Total volume of dilute | 765 | 525 | 1104 | 1035 | 855 |
| acid required (mL) | | | | | |

### 3. Cerium Depletion Operation Results

The initial level of cerium in mixed rare earth sulfate solution ((RE)₂(SO₄)₃) was 45.1 wt. %. of the total rare earth content (TREO). Table 6 below shows test results, particularly for concentrations of rare earth elements in solid filter cakes as determined for acid washed solids.

TABLE 6
Concentration of rare earths in cake after acid washing (3x)

| | Test 9 | Test 10 | Test 11 | Test 12 | Test 13 |
|---|---|---|---|---|---|
| Feed type | RES | RES | RES | RES | RES |
| La₂O₃/REO (wt. %) | 3.16 | 1.67 | 0.71 | 0.58 | 0.82 |
| CeO₂/REO (wt. %) | 92.85 | 96.24 | 98.40 | 98.56 | 98.14 |
| Pr₆O₁₁/REO (wt. %) | 1.16 | 0.68 | 0.47 | 0.43 | 0.45 |
| Nd₂O₃/REO (wt. %) | 2.44 | 1.19 | 0.46 | 0.37 | 0.54 |
| Sm₂O₃/REO (wt. %) | 0.40 | 0.26 | 0.15 | 0.19 | 0.19 |
| Eu₂O₃/REO (wt. %) | 0.05 | 0.03 | 0.00 | 0.01 | 0.01 |
| Gd₂O₃/REO (wt. %) | 0.04 | 0.02 | <0.001 | <0.001 | 0.00 |
| Tb₄O₇/REO (wt. %) | <0.002 | <0.002 | <0.002 | <0.002 | <0.002 |
| Dy₂O₃/REO (wt. %) | <0.002 | <0.002 | <0.002 | <0.002 | <0.002 |
| Y₂O₃/REO (wt. %) | 0.00 | 0.00 | <0.002 | <0.002 | <0.002 |
| Ho₂O₃/REO (wt. %) | <0.001 | <0.001 | <0.001 | <0.001 | <0.001 |
| Er₂O₃/REO (wt. %) | 0.02 | 0.02 | 0.02 | 0.02 | 0.02 |
| Tm₂O₃/REO (wt. %) | <0.002 | <0.002 | <0.002 | <0.002 | <0.002 |
| Yb₂O₃/REO (wt. %) | <0.005 | <0.005 | <0.005 | <0.005 | <0.005 |
| Lu₂O₃/REO (wt. %) | <0.005 | <0.005 | <0.005 | <0.005 | <0.005 |
| Concentration of | 76.45 | 78.14 | 74.07 | 75.14 | 77.07 |
| CeO₂/REO in cake | | | | | |
| before washing | | | | | |
| (wt. %) | | | | | |
| Concentration of | 92.85 | 96.24 | 98.40 | 98.86 | 98.14 |
| CeO₂/REO in cake | | | | | |
| after washing (wt. %) | | | | | |
| Ce removal rate | 33 | 23 | 81 | 81 | 60 |
| (wt. %) - before | | | | | |
| washing | | | | | |
| Ce removal rate | 6 | Dissolved | 34 | 53 | 27 |
| (wt. %) - after | | | | | |
| washing | | | | | |
| NdPr/REO losses to | 4 | — | 1 | 1 | 1 |
| cake after washing | | | | | |

After a 4-hour cerium depletion operation for the (RE)₂(S₄)₃ solution, the cerium removal rate was 33 wt. % to 81 wt. %. After washing, the sum of light rare earth. (Neodymium (Nd) and Praseodymium (Pr)) losses were from 1 wt. % to 4 wt. %.

### C. Pilot Scale Example 3

A test was conducted for cerium depletion operations in a one cubic meter pilot scale operation. The results are discussed below.

### 1. Raw Materials and Chemicals

Table 6 below provides details of the composition of mixed rare earth sulfate solutions used in this example.

TABLE 7
Details about the composition of mixed rare earth sulfate
solution ((RE)₂(SO₄)₃) (or RES) used in the pilot scale.

| | Unit of | | | Unit of | |
|---|---|---|---|---|---|
| Analyte | Measure | Value | Analyte | Measure | Value |
| REO | Moles/L | 0.15 | Al | ppm | — |
| La₂O₃/REO | wt. % | 25.59 | As | ppm | 6.3 |
| CeO₂/REO | wt. % | 46.26 | Ba | ppm | — |
| Pr₆O₁₁/REO | wt. % | 5.527 | Ca | ppm | 1113 |
| Nd₂O₃/REO | wt. % | 18.02 | Cu | ppm | — |
| Sm₂O₃/REO | wt. % | 2.34 | Fe | ppm | 0.5 |
| Eu₂O₃/REO | wt. % | 0.50 | Hg | ppm | — |
| Gd₂O₃/REO | wt. % | 0.95 | Mg | ppm | 14360 |
| Tb₄O₇/REO | wt. % | 0.08 | Mn | ppm | 648 |
| Dy₂O₃/REO | wt. % | 0.21 | Na | ppm | 2.9 |
| Y₂O₃/REO | wt. % | 0.46 | Ni | ppm | 2.75 |
| Ho₂O₃/REO | wt. % | 0.02 | Pb | ppm | — |
| Er₂O₃/REO | wt. % | 0.02 | Se | ppm | — |
| Tm₂O₃/REO | wt. % | 0.01 | Zn | ppm | 111.7 |
| Yb₂O₃/REO | wt. % | 0.01 | SiO₂ | ppm | 89 |
| Lu₂O₃/REO | wt. % | <0.005 | SO₄ | wt. % | 7.51 |
| | | | pH | — | 3.66 |

### 2. Process Conditions

A mixed rare earth sulfate solution (Table 7) was filtered, and then added into a vessel and agitated. An overhead agitator was used for mixing. The vessel contents were initially maintained at ambient temperature: 25° C.+/−2° C. without heating or cooling. The pH was continuously monitored using a pH probe and meter. The pH was manually adjusted in the pH range (pH 3.8-4.0) by adding the pH adjusting agent. As required, the sulfate to cerium molar ratio was fixed by manually adding the sulfate containing solid, e.g., magnesium sulfate.

After pH adjustment and addition of sulfate containing solid, the process continued with the oxidation step. The temperature of the reaction mixture was increased to 39° C. to 54° C. without application of external heat source. The oxidizing agent (H₂O₂) was fed into the reaction mixture using a centrifugal pump to control the flowrate at 500 mL/min for the total volume of rare earth sulfate of 1 cubic meter. The reaction mixture was not aerated. Upon the addition of hydrogen peroxide, the pH of the reaction mixture dropped, and the color changed from clear light brown to dark brown. As the oxidation reaction progressed, the pH was maintained in a constant range (3.8 to 4.0) by manually adding the pH adjusting agent to the reaction mixture. The oxidation reaction was allowed to occur over a period of two hours. Upon reaching 2 hours, the dosing of oxidizing agent was stopped, which leads to a spike in pH resulting from any excess pH adjusting agent in the reaction mixture. The pH was reduced by doping in additional oxidizing agent (H₂O₂) for a period of 4 hours maintaining pH in range 3.8 to 4.0 while maintaining the operating temperature (39° C. to 54° C.).

Once reaction time (4 hrs.) had been completed, the reaction mixture was filtered using a plate filter to obtain an unwashed filter cake and filtrate. The unwashed filter cake was collected and weighed; the amount of wash solution required was calculated as 1 g REO of filter cake to 10 mL of 0.21 M sulfuric acid solution. During the first wash, the unwashed filter cake was mixed with the necessary quantity of wash solution, stirred using agitator at 900 rpm for 15 minutes; filtered, and solids were collected. The washing process was repeated an additional 2 times using the same technique to yield washed filter cake.

Table 8 below shows various process parameters for experimental conversion operations for Example 3.

TABLE 8
Process parameters for experimental conversion operations.

| | Test 14 |
|---|---|
| Feed type | RES |
| Feed concentration (g/L) | 21.10 |
| SO₄/Ce Ratio | 16.77 |
| H₂O₂ concentration (%) | 30 |
| Feed volume (L) | 1000 |
| H₂O₂ flow (mL/min) - 2 hr | 500 |
| Reaction time (hrs) | 4 |
| Reaction temp (° C.) | 39-54 |
| Agitation speed (rpm) | 900 |
| Reaction pH | 3.8-4.0 |
| Concentration of dilute acid (M) | 0.21 |
| Washing times | 3 |
| Washing temperature | Ambient |
| Washing speed (rpm) | 900 |
| Filtration time (per cycle) (min) | 50-60 |
| Mass of cake produced (g) after sampling | 1700 |
| Volume of dilute acid required (per wash) (mL) | 8500 |
| Total volume of dilute acid required (mL) | 25500 |

### 3. Cerium Depletion Operation Results

The initial level of cerium in mixed rare earth sulfate solution ((RE)₂(SO₄)₃) was 45.1 wt. %. which is the percentage of total rare earth content (TREO). Table 9 below shows test results, particularly for concentrations of rare earth elements in solid filter cakes as determined for acid washed solids.

TABLE 9
Concentration of rare earths in cake after acid washing (3x)

| | Test 14 |
|---|---|
| Feed type | RES |
| La₂O₃/REO (wt. %) | 0.42 |
| CeO₂/REO (wt. %) | 98.76 |
| Pr₆O₁₁/REO (wt. %) | 0.383 |
| Nd₂O₃/REO (wt. %) | 0.43 |
| Sm₂O₃/REO (wt. %) | 0.164 |
| Eu₂O₃/REO (wt. %) | <0.001 |
| Gd₂O₃/REO (wt. %) | 0.003 |
| Tb₄O₇/REO (wt. %) | <0.002 |
| Dy₂O₃/REO (wt. %) | <0.002 |
| Y₂O₃/REO (wt. %) | <0.002 |
| Ho₂O₃/REO (wt. %) | <0.001 |
| Er₂O₃/REO (wt. %) | 0.023 |
| Tm₂O₃/REO (wt. %) | <0.002 |
| Yb₂O₃/REO (wt. %) | <0.005 |
| Lu₂O₃/REO (wt. %) | <0.005 |
| Concentration of CeO₂/REO in cake before washing | 81.20 |
| Concentration of CeO₂/REO in cake after washing | 98.76 |
| Ce removal rate (wt. %) - before washing | 62 |
| Ce removal rate (wt. %) - after washing | 55 |
| NdPr/REO losses to cake after washing (wt. %) | 1 |

After a 4-hour cerium depletion operation for the (RE)₂(SO₄)₃ solution, the cerium removal rate was 62 wt. % after washing, while the sum of the light rare earths (neodymium (Nd) and praseodymium (Pr)) losses was 1 wt. %.

### EXEMPLARY EMBODIMENTS

For reasons of completeness, various aspects of the technology are set out in the following numbered embodiments:

Embodiment 1. A method for preparing a mixed rare earth sulfate solution depleted of cerium, the method comprising:
mixing a mixed rare earth sulfate solution with a pH adjusting agent comprising a magnesium oxide, and
adding a sulfate adjusting agent comprising magnesium sulfate to the mixed rare earth sulfate solution, thereby generating a mixture;
adding an oxidizing agent to the mixture thereby generating a slurry comprising insoluble cerium (IV) hydroxide, the oxidizing agent comprising hydrogen peroxide (H₂O₂); and
filtering the slurry, thereby generating a cerium depleted mixed rare earth sulfate solution and cerium-rich mixed rare earth solids.

Embodiment 2. The method according to embodiment 1, further comprising:
agitating and heating while mixing the mixed rare earth sulfate solution with the pH adjusting agent;
agitating and heating the mixture; and
agitating and heating the slurry.

Embodiment 3. The method according to embodiment 1 or 2, wherein cerium comprises 30% by weight (wt. %) to 50 wt. % of the rare earth elements in the mixed rare earth sulfate solution.

Embodiment 4. The method according to embodiment 2 or 3, wherein the pH of the mixture during agitating is about 3.8 to 4.0.

Embodiment 5. The method according to any one of embodiments 1-4, the mixture comprising a molar ratio of sulfate (SO₄) to cerium is between 12.0 and 17.0.

Embodiment 6. The method according to according to any one of embodiments 2-5, wherein the pH of the slurry during agitating is 3.8 to 5.0.

Embodiment 7. The method according to any one of embodiments 1-6, further comprising controlling a temperature of the slurry to be 50° C. to 70° C.

Embodiment 8. The method according to any one of embodiments 2-7, wherein mixing the mixed rare earth sulfate solution with the pH adjusting agent is performed continuously;
wherein adding the oxidizing agent is performed continuously; and
wherein generating the cerium depleted mixed rare earth sulfate solution from the mixture is performed continuously.

Embodiment 9. The method according to any one of embodiments 1-8, wherein a total rare earth oxide content of the mixed rare earth sulfate solution is between 0.1 and 0.2 moles per liter total rare earth oxide.

Embodiment 10. The method according to any one of embodiments 1-9, wherein the pH adjusting agent comprises magnesium oxide (MgO).

Embodiment 11. The method according to any one of embodiments 1-10, further comprising washing the cerium-rich mixed rare earth solids after filtering the slurry.

Embodiment 12. The method according to embodiment 11, wherein the cerium-rich mixed rare earth solids are washed with a dilute acid solution.

Embodiment 13. The method according to any one of embodiments 1-12, wherein a cerium concentration of the cerium depleted mixed rare earth sulfate solution is 1 wt. % to 5 wt. % of a cerium concentration in the mixed rare earth sulfate solution.

Embodiment 14. The method according to any one of embodiments 1-13, wherein the cerium-rich mixed rare earth solids comprise cerium at 95 wt. % to 99 wt. %.

Embodiment 15. A system for generating cerium depleted mixed rare earth sulfate solutions, the system comprising:
a vessel in communication with a mixed rare earth sulfate solution source, a magnesium oxide (MgO) solution source, a magnesium sulfate (MgSO₄) source, and a hydrogen peroxide (H₂O₂) source,
   the vessel comprising agitation apparatus; and
a filter unit in fluid communication with the vessel.

Embodiment 16. The system according to embodiment 15, the filter unit generating:
a solids portion comprising cerium(IV)-rich solid containing less than 1 to 15 percent by weight (wt. %) of total rare earth oxides of light rare earths; and
a liquid filtrate comprising a cerium depleted mixed rare earth sulfate solution with a cerium removal rate between 33 wt. % and 81 wt. %.

Embodiment 17. The system according to embodiment 16, wherein the solids portion is in fluid communication with a washing system, the washing system comprising:
1-3 washing tanks, each washing tank in fluid communication with a washing solution source.

Embodiment 18. The system according to any one of embodiments 15-17, the vessel comprising temperature regulation components configured to maintain a vessel fluid temperature between 50° C. and 70° C.

Embodiment 19. The system according to any one of embodiments 15-18, further comprising pH control apparatus configured to maintain a pH of fluid in the vessel at a pH between 3.8 and 5.0.

Embodiment 20. The system according to any one of embodiments 15-19, wherein the filter unit is a vacuum or plate filter.

It is understood that the foregoing detailed description and accompanying examples are merely illustrative and are not to be taken as limitations upon the scope of the disclosure. Various changes and modifications to the disclosed embodiments will be apparent to those skilled in the art. Such changes and modifications, including without limitation those relating to the chemical structures, substituents, derivatives, intermediates, syntheses, compositions, formulations, or methods of use, may be made without departing from the spirit and scope of the disclosure.

1. A method for preparing a mixed rare earth sulfate solution depleted of cerium, the method comprising:
mixing a mixed rare earth sulfate solution with a pH adjusting agent comprising a magnesium oxide, and
adding a sulfate adjusting agent comprising magnesium sulfate to the mixed rare earth sulfate solution, thereby generating a mixture;
adding an oxidizing agent to the mixture thereby generating a slurry comprising insoluble cerium (IV) hydroxide, the oxidizing agent comprising hydrogen peroxide (H₂O₂); and
filtering the slurry, thereby generating a cerium depleted mixed rare earth sulfate solution and cerium-rich mixed rare earth solids.

2. The method according to claim 1, further comprising:
agitating and heating while mixing the mixed rare earth sulfate solution with the pH adjusting agent;
agitating and heating the mixture; and
agitating and heating the slurry.

3. The method according to claim 1, wherein cerium comprises 30% by weight (wt. %) to 50 wt. % of the rare earth elements in the mixed rare earth sulfate solution.

4. The method according to claim 2, wherein the pH of the mixture during agitating is about 3.8 to 4.0.

5. The method according to claim 1, the mixture comprising a molar ratio of sulfate (SO₄) to cerium is between 12.0 and 17.0.

6. The method according to claim 2, wherein the pH of the slurry during agitating is 3.8 to 5.0.

7. The method according to claim 1, further comprising controlling a temperature of the slurry to be 50° C. to 70° C.

8. The method according to claim 2, wherein mixing the mixed rare earth sulfate solution with the pH adjusting agent is performed continuously;
wherein adding the oxidizing agent is performed continuously; and
wherein generating the cerium depleted mixed rare earth sulfate solution from the mixture is performed continuously.

9. The method according to claim 1, wherein a total rare earth oxide content of the mixed rare earth sulfate solution is between 0.1 and 0.2 moles per liter total rare earth oxide.

10. The method according to claim 1, wherein the pH adjusting agent comprises magnesium oxide (MgO).

11. The method according to claim 1, further comprising washing the cerium-rich mixed rare earth solids after filtering the slurry.

12. The method according to claim 11, wherein the cerium-rich mixed rare earth solids are washed with a dilute acid solution.

13. The method according to claim 1, wherein a cerium concentration of the cerium depleted mixed rare earth sulfate solution is 1 wt. % to 5 wt. % of a cerium concentration in the mixed rare earth sulfate solution.

14. The method according to claim 1, wherein the cerium-rich mixed rare earth solids comprise cerium at 95 wt. % to 99 wt. %.

15. A system for generating cerium depleted mixed rare earth sulfate solutions, the system comprising:
a vessel in communication with a mixed rare earth sulfate solution source, a magnesium oxide (MgO) solution source, a magnesium sulfate (MgSO₄) source, and a hydrogen peroxide (H₂O₂) source,
the vessel comprising agitation apparatus; and
a filter unit in fluid communication with the vessel.

16. The system according to claim 15, the filter unit generating:
a solids portion comprising cerium(IV)-rich solid containing less than 1 to 15 percent by weight (wt. %) of total rare earth oxides of light rare earths; and
a liquid filtrate comprising a cerium depleted mixed rare earth sulfate solution with a cerium removal rate between 33 wt. % and 81 wt. %.

17. The system according to claim 16, wherein the solids portion is in fluid communication with a washing system, the washing system comprising:
1-3 washing tanks, each washing tank in fluid communication with a washing solution source.

18. The system according to claim 15, the vessel comprising temperature regulation components configured to maintain a vessel fluid temperature between 50° C. and 70° C.

19. The system according to claim 15, further comprising pH control apparatus configured to maintain a pH of fluid in the vessel at a pH between 3.8 and 5.0.

20. The system according to claim 15, wherein the filter unit is a vacuum or plate filter.
